(19) United States
(12) Patent Application Publication
(10) Pub. No.: US 2024/0006692 A1
(43) Pub. Date: Jan. 4, 2024

(54) ELECTRONIC ENCLOSURE WITH STRESS CONCENTRATING FEATURE

(71) Applicant: Apple Inc., Cupertino, CA (US)

(72) Inventors: Abhishek P. Shiwalkar, Scotts Valley, CA (US); Karthick Chandraseker, San Jose, CA (US); Yuli Huang, San Francisco, CA (US); Christopher R. Pasma, Redwood City, CA (US); Hirotsugu Oba, Sunnyvale, CA (US); Dhaval D. Lokagariwar, San Jose, CA (US)

(21) Appl. No.: 17/853,622

(22) Filed: Jun. 29, 2022

(51) Int. Cl. H01M 50/131; H01M 50/169

(52) U.S. Cl. CPC H01M 50/131; H01M 50/169

(57) ABSTRACT

An electronic enclosure includes walls that extend crosswise from one another to define a portion of an internal volume of the electronic enclosure. The walls extend from one another via an interface formed between the walls. The interface includes a notch, such as an arcuate portion, configured to concentrate stress caused by pressure buildup within the internal volume such that an amount of stress at the notch is greater than an amount of stress at other portions of the electronic enclosure.

### BACKGROUND

The present disclosure relates generally to stress in an electronic enclosure. More specifically, the present disclosure relates to mitigating heat- and/or pressure-induced stress in the electronic enclosure.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic enclosures (e.g., electrical enclosures), such as hermetically sealed enclosures, may be used to enclose various electrical components, such as a battery, a conductor, a microchip, and so forth. The electrical components may provide various functions for an electric device (e.g., an electronic device), such as by providing power to the electric device and/or controlling operation of the electric device. An electronic enclosure may shield the electrical components from external elements (e.g., dirt, debris) to maintain a structural integrity and/or a desirable operation of the electrical components. During operation of the electrical components, pressure may build within the electronic enclosure. For example, operation of the electrical components may produce heat, which increases the pressure within the electronic enclosure. In some circumstances, the pressure buildup may impart stress on certain portions of the electronic enclosure.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic enclosure includes a first wall extending along a first direction, and a second wall extending along a second direction crosswise to the first direction. The first wall and the second wall cooperatively define at least a portion of an internal volume of the electronic enclosure. The electronic enclosure further includes an interface formed between the first wall and the second wall such that the first wall and the second wall extend from one another via the interface. The interface comprises a notch configured to concentrate stress caused by pressure buildup within the internal volume.

In another embodiment, an electronic enclosure includes an arcuate portion, a first wall extending from a first end of the arcuate portion, and a second wall extending from a second end of the arcuate portion. The first wall, the second wall, and the arcuate portion cooperatively define at least a portion of an internal volume of the electronic enclosure, the arcuate portion curves inwardly with respect to the first wall and the second wall, and the arcuate portion is configured to concentrate stress caused by pressure buildup within the internal volume.

In yet another embodiment, an electronic enclosure includes a base having a first wall, a second wall, and a first interface extending between the first wall and the second wall. The electronic enclosure also includes a cover having a first edge, a second edge, and a second interface extending between the first edge and the second edge. The first interface forms a first notch, and the second interface forms a second notch. The base and the cover are coupled to one another in an assembled configuration of the electronic enclosure to enclose an internal volume of the electronic enclosure, and the first notch and the second notch are configured to concentrate stress caused by pressure buildup in the internal volume, thereby facilitating relief of the pressure buildup from within the electronic enclosure at the first notch and the second notch.

### BRIEF DESCRIPTION OF THE DRAWINGS

Various aspects of this disclosure may be better understood upon reading the following detailed description and upon reference to the drawings in which:

FIG. 1 is a block diagram of an electronic device, according to embodiments of the present disclosure;

FIG. 2 is a first side perspective view of an electronic enclosure that may be employed in the electronic device of FIG. 1, according to embodiments of the present disclosure;

FIG. 3 is a second side perspective view of the electronic enclosure of FIG. 2, according to embodiments of the present disclosure;

FIG. 4 is a top view of the electronic enclosure of FIG. 2, according to embodiments of the present disclosure;

FIG. 5 is a detailed side view of a portion of the electronic enclosure of FIG. 2, according to embodiments of the present disclosure;

FIG. 6 is a side perspective view of a portion of the electronic enclosure of FIG. 2 having a different arrangement of interfaces, according to embodiments of the present disclosure;

FIG. 7 is a top view of an electronic enclosure that may be employed in the electronic device of FIG. 2 with adjusted dimensions, according to embodiments of the present disclosure;

FIG. 8 is a top view of an electronic enclosure that may generally have a hexagonal shape, according to embodiments of the present disclosure;

FIG. 9 is a perspective view of an electronic enclosure having a generally spherical shape, according to embodiments of the present disclosure; and

FIG. 10 is a flowchart of a method for manufacturing the electronic enclosure of FIG. 2, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be noted that any exact values, numbers, measurements, and so on, provided herein, are contemplated to include approximations (e.g., within a margin of suitable or contemplatable error) of the exact values, numbers, measurements, and so on).

The present disclosure relates generally to an electronic enclosure that encloses an electrical component. For example, the electronic enclosure may be hermetically sealed to block passage of air and other elements between an interior of the electronic enclosure and an external environment. Thus, the electronic enclosure may better enclose the electrical component, such as by blocking various external elements (e.g., dust, debris) from contacting the electrical component. In this manner, the electronic enclosure may facilitate maintaining a structural integrity of the electrical component, facilitating desirable operation of the electrical component, improving a useful lifespan of the electrical component, and so forth.

Operation of the electrical component may increase a pressure within the electronic enclosure. As an example, the operation of the electrical component may produce heat within the electronic enclosure. The heat may cause a buildup of pressure within the electronic enclosure, and the buildup of pressure may impart an amount of stress onto different portions of the electronic enclosure. As an example, the stress may be imparted against walls of the electronic enclosure, and a sufficient amount of stress may cause a change in geometry of one of the walls. It may be desirable to manufacture the electronic enclosure to reduce or lessen a relative amount of stress being imparted at a certain portion of the electronic enclosure. As an example, it may be more desirable for a greater amount of stress to be imparted onto a first wall instead of onto a second wall. For instance, the second wall may include a mounting or coupling feature that may provide additional functionality for the electronic enclosure, and the first wall may not include any mounting or coupling features. Therefore, a potential change in the geometry of the first wall (e.g., cause by a threshold amount of stress imparted onto the first wall) may have a relatively less impact on the overall functionality of the electronic enclosure, such as operation of the electrical component, as well as operation of neighboring electrical components, as compared to a potential change in the geometry of the second wall.

Thus, embodiments of the present disclosure are directed to an electronic enclosure that is arranged to form a notch, which may concentrate stress during a pressure buildup within the electronic enclosure. That is, a relatively greater amount of stress may be imparted onto the electronic enclosure at the notch formed by the walls. Correspondingly, a relatively lower amount of stress may be imparted onto the electronic enclosure at other portions of the electronic enclosure. For example, the notch may reduce stress being imparted at certain portions of the electronic enclosure during a pressure buildup, thereby reducing potential of a change in geometry at such portions of the electronic enclosure. In this manner, the notch may provide more desirable relative amounts of stress at various portions of the electronic enclosure during a pressure buildup.

In some embodiments, the electronic enclosure may be manufactured to have certain characteristics to concentrate stress via the notch. For example, a location of the notch, a dimension (e.g., a width, a length) of the electronic enclosure, a coupling between different portions (e.g., a base, a cover) of the electronic enclosure, and so forth may be selected to concentrate stress in a particular manner. Additionally, manufacture of the electronic enclosure may readily form the notch. For example, arranging walls of the electronic enclosure relative to one another may directly form the notch without having to perform an additional, separate manufacturing operation (e.g., an indentation operation, a cutting operation, an etching operation, a stamping operation, a scoring operation, a punching operation, a drilling operation) dedicated to forming the notch. In other words, the notch may be a part of the geometry of the electronic enclosure. As such, the notch may be more easily manufactured, and an overall cost, time of labor, and/or complexity associated with fabrication of the electronic enclosure may be reduced. Moreover, the notch may appear to be more naturally or monolithically implemented, such as being a part of the electronic enclosure profile and instead of being an additional, separate feature applied to the electronic enclosure. In this way, the electronic enclosure having the notch may appear more aesthetically pleasing.

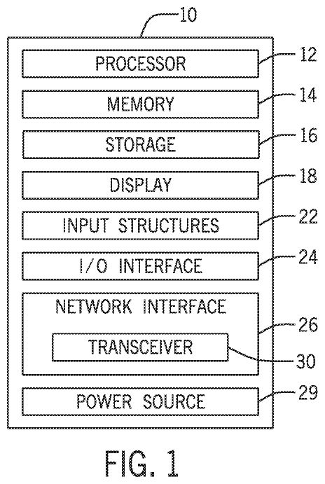

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, the memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable the electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol.

The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth). The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

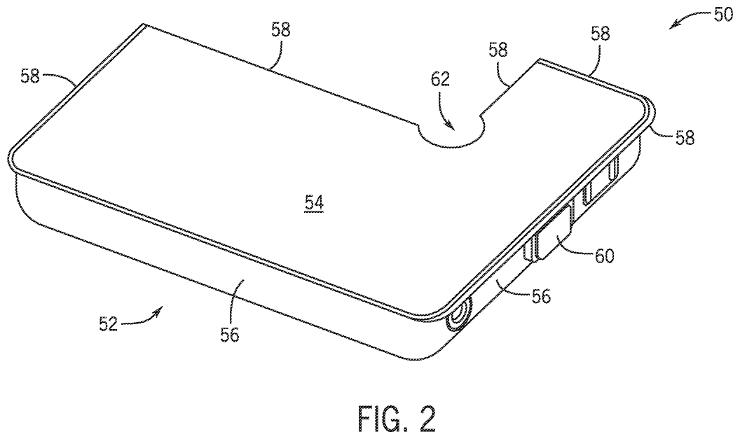

FIG. 2 is a first side perspective view of an embodiment of an electronic enclosure 50 that may be employed in the electronic device 10 of FIG. 1. The electronic enclosure 50 may be, for example, part of the power source 29 (e.g., an enclosure of a battery). In the illustrated embodiment, the electronic enclosure 50 may include a base 52 and a cover 54 coupled to one another. The base 52 may include a plurality of walls 56 that define an internal volume (e.g., an interior space) of the electronic device 10. An electrical component, such as a battery, may be disposed within the internal volume. The cover 54 may include a plurality of edges 58. In an assembled configuration of the electronic enclosure 50, the cover 54 may be coupled to the base 52 to enclose the internal volume, such as to cover and protect the electronic component disposed within the internal volume. For example, each edge 58 of the plurality of edges 58 of the cover 54 may engage with a corresponding wall 56 of the plurality of walls 56 of the base 52.

In some embodiments, engagement between the base 52 and the cover 54 may provide a seal (e.g., a hermetic seal) that blocks flow of elements between the internal volume of the electronic enclosure 50 and a surrounding, external environment (e.g., external to the electronic enclosure 50). For example, a weld, an adhesive, a brazed material, or any other suitable feature may be used to secure (e.g., directly couple) the base 52 and the cover 54 to one another and seal an interface between the base 52 and the cover 54. In this manner, the electronic enclosure 50 may better protect the electrical component from certain external elements, such as dust, debris, liquid, gas, chemicals, and so forth.

Additionally, the electronic enclosure 50 may include an I/O feature 60 (e.g., an I/O port) that may be formed through one or more of the walls 56. The I/O feature 60 may enable electrical coupling with the electrical component disposed within the electronic enclosure 50. By way of example, the I/O feature 60 may enable current flow to and/or from the electrical component, signal transmission to and/or from the electrical component, and so forth. For instance, the I/O feature 60 may receive an electrical connector that electrically couples the electrical component with another device.

During operation of the electrical component, pressure may build up within the internal volume of the electronic enclosure 50, such as via heat produced by the operation of the electrical component. The pressure buildup may impart stress onto the electronic enclosure 50. For example, the pressure buildup may distribute the stress onto different areas of the electronic enclosure 50 (e.g., onto base 52, onto the cover 54, onto an interface between the base 52 and the cover 54). The walls 56 of the base 52 and/or the edges 58 of the cover 54 may form a geometric feature 62 that may include a local distortion and/or structural discontinuity, such as a notch. The geometric feature 62 may concentrate the stress at a portion of the electronic enclosure 50 around the geometric feature 62 during a pressure buildup. That is, more stress may be distributed to and imparted on the area associated with the geometric feature 62. Correspondingly, less stress may be distributed to and imparted on other portions of the electronic enclosure 50. For instance, the geometric feature 62 may reduce stress being imparted onto an area (e.g., one of the walls 56) associated with the I/O feature 60. In this manner, the geometric feature 62 may facilitate blocking a potential change in geometry of the I/O feature 60 during a pressure buildup, thereby maintaining a structural integrity and/or enabling continued operation of the I/O feature 60.

As described herein, the geometric feature 62 formed by the electronic enclosure 50 may be directly formed via arrangement of the walls 56 of the base 52 and/or the edges 58 of the cover 54. That is, the geometric feature 62 may be integral with the base 52 and/or the cover 54 and may already be incorporated upon forming the walls 56 and/or the edges 58 instead of, for example, incorporated as a separate feature (e.g., an indentation, a punch, a cutout) that is applied to the walls 56 and/or the edges 58, such as after the walls 56 and/or the edges 58 have been formed. In this manner, a complexity (e.g., a quantity of different types of operations), a cost (e.g., for equipment performing different types of operations), and/or a time (e.g., a quantity of distinct operations being performed) associated with to fabrication and/or assembly of the electronic enclosure 50 may be reduced via implementation of the geometric feature 62 disclosed herein.

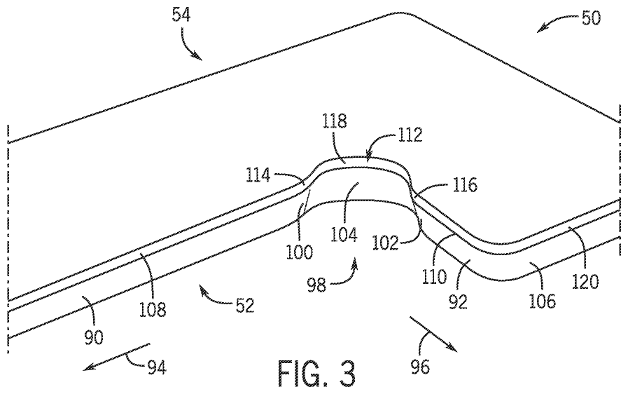

FIG. 3 is a second side perspective view of an embodiment of the electronic enclosure 50. In the illustrated embodiment, the base 52 includes a first wall 90 and a second wall 92. The first wall 90 may extend along (e.g., linearly extend along) a first direction or axis 94, and the second wall 92 may extend along (e.g., linearly extend along) a second direction or axis 96, which may be crosswise relative to the first direction 94. For example, the second direction 96 may be oriented perpendicularly (e.g., orthogonally) or obliquely with respect to the second direction 96. A first interface 98 may extend between the first wall 90 and the second wall 92. That is, the first wall 90 and the second wall 92 may extend from one another via the first interface 98.

In the illustrated embodiment, the first interface 98 includes multiple arcuate portions. For example, a first arcuate portion 100 (e.g., a first bend) may extend from the first wall 90 at the first interface 98, a second arcuate portion 102 (e.g., a second bend) may extend from the second wall 92 at the first interface 98, and a third arcuate portion 104 (e.g., a third bend) may extend from the first arcuate portion 100 to the second arcuate portion 102. Thus, the first arcuate portion 100 and the second arcuate portion 102 may extend from opposite ends of the third arcuate portion 104 to the first wall 90 and the second wall 92, respectively. The first interface 98 may therefore include a notch that curves inwardly relative to the first wall 90 and the second wall 92 in the illustrated embodiment.

A relatively increased amount of stress may be imparted at the arcuate portions 100, 102, 104 of the first interface 98 during pressure buildup within the electronic enclosure 50. For example, the pressure buildup may cause relatively greater stress to be imparted onto the arcuate portions 100, 102, 104 as compared to the stress imparted onto a third wall 106 extending from the second wall 92. In other words, the geometry of the first interface 98 may divert stress away from the third wall 106 and onto the arcuate portions 100, 102, 104 instead. In this manner, the first interface 98 may distribute the stress caused by the pressure buildup in a more desirable manner. For example, electronic components external to the electronic enclosure 50 may be positioned near the third wall 106, and not positioned along the arcuate portions 100, 102, 104, such that the electronic components may avoid effects of pressure buildup that are more likely to impact the arcuate portions 100, 102, 104.

The cover 54 may include a first edge 108 and a second edge 110. In the assembled configuration of the electronic enclosure 50, the first edge 108 may engage with (e.g., directly couple to) the first wall 90 of the base 52, and the second edge 110 may engage with (e.g., directly couple to) the second wall 92 of the base 52. For example, the first edge 108 may extend along the first direction 94, and the second edge 110 may extend along the second direction 96 in the assembled configuration. The first edge 108 and the second edge 110 may extend from one another via a second interface 112.

The second interface 112 may also include multiple arcuate portions, such as a fourth arcuate portion 114 (e.g., a fourth bend) that may extend from the first edge 108 at the second interface 112, a fifth arcuate portion 116 (e.g., a fifth bend) that may extend from the second edge 110 at the second interface 112, and a sixth arcuate portion 118 (e.g., a sixth bend) that may extend from the fourth arcuate portion 114 to the fifth arcuate portion 116. The second interface 112 may include an additional notch that curves inwardly relative to the first edge 108 and the second edge 110.

A relatively increased amount of stress may be imparted at the arcuate portions 114, 116, 118 of the second interface 112 during pressure buildup within the electronic enclosure 50, such as to divert stress away from and/or reduce stress at a third edge 120 extending from the second edge 110. In some embodiments, the first arcuate portion 100 of the first interface 98 may engage with the fourth arcuate portion 114 of the second interface 112, the second arcuate portion 102 of the first interface 98 may engage with the fifth arcuate portion 116 of the second interface 112, and/or the third arcuate portion 104 of the first interface 98 may engage with the sixth arcuate portion 118 of the second interface 112 in the assembled configuration of the electronic enclosure 50. In this manner, the engagement between the first interface 98 and the second interface 112 may cooperatively concentrate stress in a desirable manner. For example, the distribution of stress during a pressure buildup within the electronic enclosure 50 may be more predictable (e.g., the location of highest stress may be more reliably determined to be at around the interfaces 98, 112) based on the arrangement of the first interface 98 and/or the second interface 112. As such, the first interface 98 and/or the second interface 112 (e.g., a shape of the first interface 98 and/or of the second interface 112, a location of the first interface 98 and/or of the second interface 112) may be formed to control distribution of stress in a more desirable manner (e.g., to provide a particular stress profile) during the pressure buildup.

By way of example, concentration of stress at the first interface 98 and/or the second interface 112 may, in some cases, change a geometry of the electronic enclosure 50 at the first interface 98 and/or the second interface 112. The change in geometry of the electronic enclosure 50 may facilitate relief of the pressure buildup at the first interface 98 and/or the second interface 112. Therefore, the arrangement of the first interface 98 and/or the second interface 112 may enable greater and/or more desirable pressure relief by providing desirable concentration of stress.

In the illustrated embodiment, the radius of the third arcuate portion 104 is substantially greater than the radii of the first arcuate portion 100 and of the second arcuate portion 102. However, in additional or alternative embodiments, the first arcuate portion 100, the second arcuate portion 102, and the third arcuate portion 104 may have any suitable radii relative to one another (e.g., the radius of the third arcuate portion 104 may be less than the radii of the first arcuate portion 100 and of the second arcuate portion 102, the radii of the first arcuate portion 100, the second arcuate portion 102, and the third arcuate portion 104 may be equal, and so on). Similarly, the radius of the sixth arcuate portion 118 is substantially greater than the radii of the fourth arcuate portion 114 and of the fifth arcuate portion 116 in the illustrated embodiment, but the fourth arcuate portion 114, the fifth arcuate portion 116, and the sixth arcuate portion 118 may have any suitable relative radii in additional or alternative embodiments. For example, a relatively small radius (e.g., 2 millimeter (mm) or less, 2.5 mm or less, 3 mm or less, 5 mm or less, and so on) of the third arcuate portion 104 and/or of the sixth arcuate portion 118 may increase the relative amount of stress at the interfaces 98, 112, but a third arcuate portion 104 having a relatively small radius may be difficult to form and/or may cause an undesirable change in geometry of the electronic enclosure 50 (e.g., affect the coupling between the base 52 and the cover 54 at the interfaces 98, 112) during a pressure buildup. A relatively high radius (e.g., 8 mm or more, 10 mm or more, 12 mm or more, 15 mm or more, and so on) of the third arcuate portion 104 and/or of the sixth arcuate portion 118 may reduce the relative amount of stress at the interfaces 98, 112, but may reduce a size of the internal volume of the electronic enclosure 50. As such, the radii of the arcuate portions 100, 102, 104, 114, 116, 118 may be selected to provide a desirable configuration or characteristic of the electronic enclosure 50, such as during a pressure buildup.

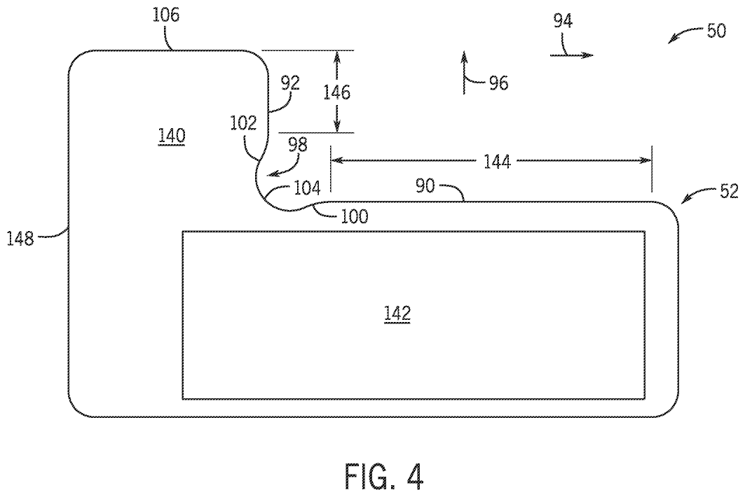

FIG. 4 is a top view of an embodiment of the base 52 of the electronic enclosure 50. For example, FIG. 4 may provide a visualization of the base 52 without the cover 54 attached thereto. As such, an internal volume 140 (e.g., a chamber, a cavity, a compartment) defined by the base 52 may be exposed. An electronic component 142 may be positioned within the internal volume 140.

In the illustrated embodiment, the first wall 90 and the second wall 92 are generally perpendicular relative to one another to form an L-shape configuration of the electronic enclosure 50. Additionally, the first wall 90 may span a first dimension 144 (e.g., a first length) in the first direction 94, the second wall 92 may span a second dimension 146 (e.g., a second length) in the second direction 96, and the first dimension 144 and the second dimension 146 may be of different magnitudes from one another. Quantitatively, the first dimension 144 may be substantially greater than the second dimension 146. However, in alternative embodiments, the second dimension 146 may be substantially greater than the first dimension 144, or the first dimension 144 and the second dimension 146 may be approximately equal to one another. Moreover, as described herein, the first interface 98 may include a notch that curves inwardly relative to the first wall 90 and/or relative to the second wall 92. By way of example, the third arcuate portion 104 may curve from the first arcuate portion 100 and/or from the second arcuate portion 102 toward a fourth wall 148 that may extend from the third wall 106 of the base 52.

Furthermore, the first interface 98 may be naturally or readily formed via manufacture of the various walls (e.g., the first wall 90, the second wall 92) of the base 52. For example, instead of removing material from a wall of the base 52 to form a geometric feature (e.g., after the first wall 90 and/or the second wall 92 have been arranged), the first interface 98 may be formed during arrangement of the first wall 90 and the second wall 92, such as bending of material (e.g., metal) to provide the illustrated orientation between the first wall 90 and the second wall 92. As such, a geometric feature that may provide stress concentration benefits may be readily formed upon establishing the walls of the base 52, and a separate operation dedicated to forming a geometric feature for concentrating stress may be avoided, thereby improving an ease of manufacture of the electronic enclosure 50. In addition, as a result of such manufacturing techniques to form the first interface 98, each of the first wall 90, the second wall 92, the first arcuate portion 100, the second arcuate portion 102, and the third arcuate portion 104 may have approximately the same thickness, thereby maintaining a desirable structural integrity of the base 52 (e.g., of the walls of the base 52) as compared to implementing a formation (e.g., a cut) that may remove a portion of the base 52.

Similar features discussed herein with respect to the base 52 may similarly be implemented for the cover 54. That is, the first edge 108, the second edge 110, the fourth arcuate portion 114, the fifth arcuate portion 116, and the sixth arcuate portion 118 may include similar parameters (e.g., dimensional relationships or ratios) as that of the first wall 90, the second wall 92, the first arcuate portion 100, the second arcuate portion, and the third arcuate portion 104, respectively. A manufacturing technique associated with the cover 54 to form the second interface 112 may also be similar to the manufacturing technique associated with the base 52 to form the first interface 98.

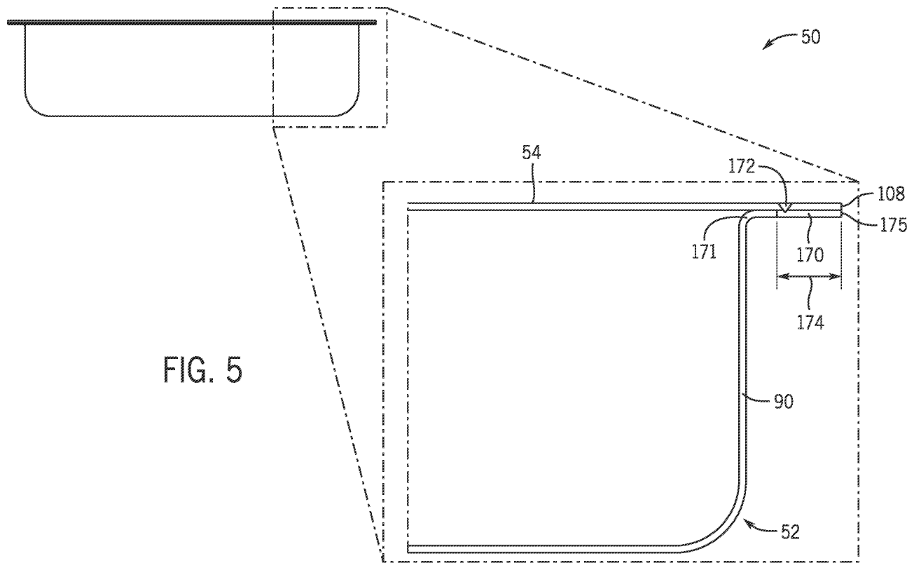

FIG. 5 is a detailed side view of an embodiment of a portion of the electronic enclosure 50 illustrating coupling between the base 52 and the cover 54. As an example, FIG. 5 may illustrate coupling between the first wall 90 of the base 52 and the first edge 108 of the cover 54. However, the features described herein may be applied to coupling between any portion of the base 52 and any portion of the cover 54, such as between the second wall 92 and the second edge 110, between the first interface 98 and the second interface 112, between the third wall 106 and the third edge 120, and so forth.

The base 52 may include a flange 170 extending from the first wall 90. For example, the first wall 90 may form a bend 171 that extends into the flange 170. The bend 171 may, for instance, have a radius between 0.01 to 0.05 mm, 0.05 mm to 0.1 mm, 0.1 mm to 0.3 mm, or any other suitable radius. The flange 170 may increase a surface area of contact between the base 52 and the cover 54. For instance, the cover 54 may be positioned flush against the flange 170. Such engagement between the cover 54 and the flange 170 may facilitate coupling between the base 52 and the cover 54. As an example, a coupling feature 172 (e.g., a weld, an adhesive, a brazed material) may be applied to the cover 54 and the flange 170 to secure the base 52 and the cover 54 to one another.

In some embodiments, a property of the flange 170 and/or of the coupling feature 172 may be arranged to concentrate stress in a particular manner. By way of example, the relative amount of stress at the coupling between the base 52 and the cover 54 may be based on a distance 174 (e.g., horizontal distance as illustrated) between the coupling feature 172 and an edge 175 of the flange 170 (e.g., in engagement with the first edge 108 of the cover 54). For instance, a relatively high amount of stress may be imparted at the coupling between the base 52 and the cover 54 having a smaller distance 174 (e.g., 0.01 mm, 0.05 mm, 0.1 mm), and a relatively low amount of stress may be imparted at the coupling between the base 52 and the cover 54 having a greater distance 174 (e.g., 0.4 mm, 0.5 mm, 0.6 mm). In this manner, the relative amount of stress at the coupling between the base 52 and the cover 54 may be controlled and established by adjusting the distance 174, such as by adjusting the positioning of the coupling feature 172 relative to the first edge 108 and/or adjusting formation of the flange 170 having a particular distance of extension from the first wall 90. Therefore, the stress concentration associated with the electronic enclosure 50 during pressure buildup may be based on collective configurations of the geometry of the base 52, the geometry of the cover 54, and/or the coupling between the base 52 and the cover 54.

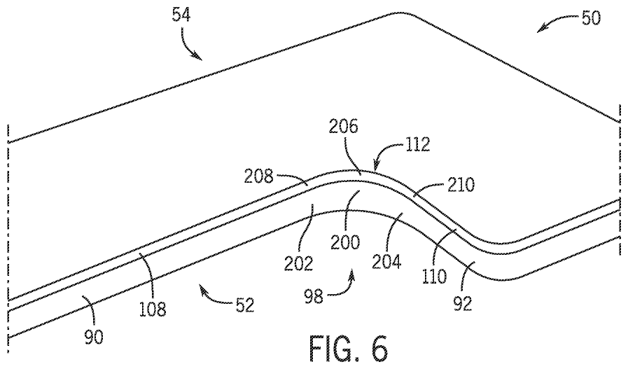

FIG. 6 is a side perspective view of an embodiment of a portion of the electronic enclosure 50 illustrating a different arrangement of the first interface 98 and the second interface 112. In the illustrated embodiment, the first interface 98 of the base 52 may include a first arcuate portion 200. Each of the first wall 90 and the second wall 92 may extend from the first arcuate portion 200. For example, the first wall 90 may extend from a first end 202 of the first arcuate portion 200, and the second wall 92 may extend from a second end 204, opposite the first end 202, of the first arcuate portion 200. Moreover, the second interface 112 of the cover 54 may include a second arcuate portion 206. The first edge 108 may extend from a first end 208 of the second arcuate portion 206, and the second edge 110 may extend from a second end 210, opposite the first end 208, of the second arcuate portion 206. In this manner, the first interface 98 may include a single first arcuate portion 200, and the second interface 112 may include a single second arcuate portion 206. Such arrangement of the first interface 98 and of the second interface 112 may concentrate stress during pressure buildup within the electronic enclosure 50. For example, the arrangement of the first interface 98 and the second interface 112 may provide different stress concentration benefits (e.g., divert a different amount of stress away from other portions of the electronic enclosure 50) with respect to the first interface 98 and the second interface 112 described with respect to FIGS. 2-4.

In additional or alternative embodiments, the first interface 98 and/or the second interface 112 may include any quantity of arcuate portions to concentrate stress in a particular manner. For example, the first interface 98 and/or the second interface 112 may include two arcuate portions, four arcuate portions, or more than four arcuate portions. Indeed, the first interface 98 and/or the second interface 112 may have a spline or serpentine profile in certain embodiments. The first interface 98 and/or the second interface 112 may additionally or alternatively include any other geometric feature configured to concentrate stress, such as a semisphere depression, a divot, a v-shaped groove, and so forth. Such geometric features at the first interface 98 may be formed during arrangement of the first wall 90 and/or the second wall 92, and such geometric features at the second interface 112 may be formed during arrangement of the first edge 108 and/or the second edge 110, instead via a separate operation dedicated to forming such geometric features, such as after the first wall 90, the second wall 92, the first edge 108, and/or the second edge 110 have already been arranged.

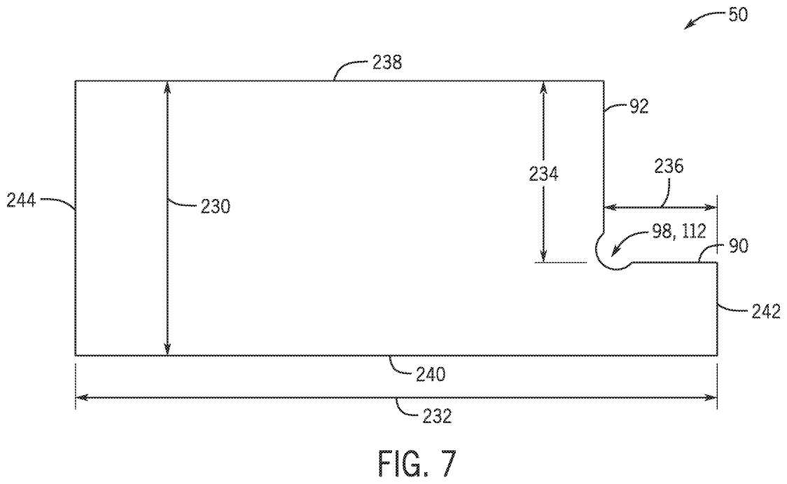

FIG. 7 is a top view of an embodiment of the electronic enclosure 50 illustrating various aspects that may be adjusted to change concentration of stress at the interfaces 98, 112, such as to change an amount of stress at the interfaces 98, 112 relative to the amount of stress at other parts of the electronic enclosure 50 during a pressure buildup. The electronic enclosure 50 provided in FIG. 7 may be representative of the base 52 and/or the cover 54. A first dimension 230 (e.g., a width), a second dimension 232 (e.g., a length), a third dimension 234 (e.g., a portion of the width), and/or a fourth dimension 236 (e.g., a portion of the length) of the electronic enclosure 50 may be selected based on desirable relative amounts of stress at the interfaces 98, 112. The first dimension 230 (e.g., 5-20 mm, 20-50 mm, 50-100 mm, 100-150 mm) may include a distance spanning from a first end 238 of the electronic enclosure 50 to a second end 240, opposite the first end 238, of the electronic enclosure 50. The second dimension 232 (e.g., 5-20 mm, 20-50 mm, 50-100 mm, 100-150 mm) may include a distance spanning from a third end 242 of the electronic enclosure 50 to a fourth end 244, opposite the third end 242, of the electronic enclosure 50. The third dimension 234 may include a distance spanning from the first end 238 to the first wall 90 and/or to one of the interfaces 98, 112. The fourth dimension 236 may include a distance spanning from the third end 242 to the second wall 92 and/or to one of the interfaces 98, 112.

As an example, reducing the third dimension 234 relative to the first dimension 230 and/or reducing the fourth dimension 236 relative to the second dimension 232 (e.g., providing an electronic enclosure 50 having a more full, rectangular shape) may reduce the amount of stress at the interfaces 98, 112 (e.g., relative to the amount of stress at the second end 240 and/or the fourth end 244). However, increasing the third dimension 234 relative to the first dimension 230 and/or increasing the fourth dimension 236 relative to the second dimension 232 may reduce a size of the internal volume within the electronic enclosure and/or may cause an undesirable change in geometry during a pressure buildup. For this reason, the electronic enclosure 50 may be manufactured with certain dimensions 230, 232, 234, 236 to provide a desirable configuration or characteristic of the electronic enclosure 50, such as at during a pressure buildup.

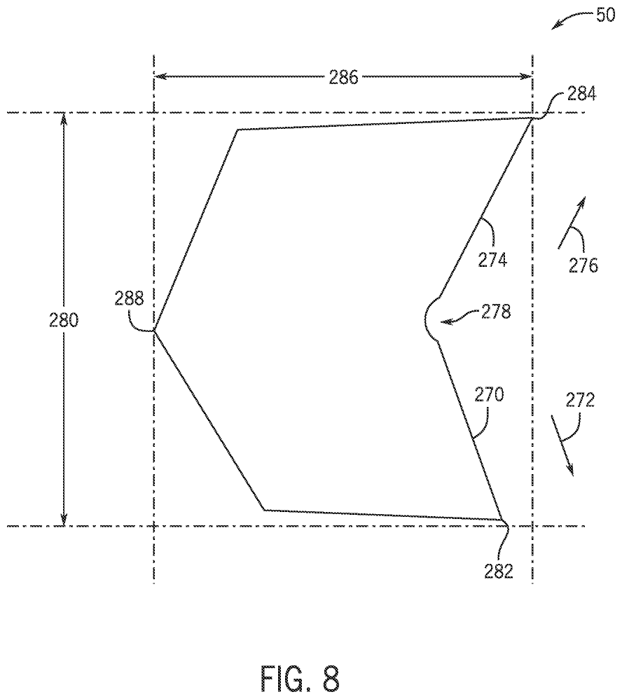

Similar geometric features for concentrating stress may also be implemented in an electronic enclosure 50 having a different geometric shape, such as a non-rectangular shape. FIG. 8 is a top view of an embodiment of an electronic enclosure 50 that may generally have a hexagonal shape. The illustrated embodiment of FIG. 8 may represent the base 52 and/or the cover 54. The electronic enclosure 50 may include a first wall 270 (e.g., a first edge) that may extend along a first direction 272. The electronic enclosure 50 may include a second wall 274 (e.g., a second edge) that may extend along a second direction 276. The first direction and the second direction 276 may be angled obliquely relative to one another. The first wall 270 and the second wall 274 may extend from one another via an interface 278, which may include a notch. Thus, stress may concentrate at the interface 278 during a pressure buildup within the electronic enclosure 50. The interface 278 may include similar features as that described with respect to the interfaces 98, 112, such as one or more arcuate portions.

Moreover, various geometric aspects of the illustrated electronic enclosure 50 may be selected to adjust concentration of stress at the interface 278. For example, relative dimensioning between the walls 270, 274, a first distance 280 (e.g., 5-20 mm, 20-50 mm, 50-100 mm, 100-150 mm) between a first end 282 of the first wall 270 and a second end 284 of the second wall 274, a second distance 286 (e.g., 5-20 mm, 20-50 mm, 50-100 mm, 100-150 mm) between a peak 288 of the electronic enclosure 50 and one of the first end 282 or the second end 284, an angle between the walls 270, 274, and so forth may be selected based on a desirable configuration or characteristic of the electronic enclosure 50, such as during a pressure buildup.

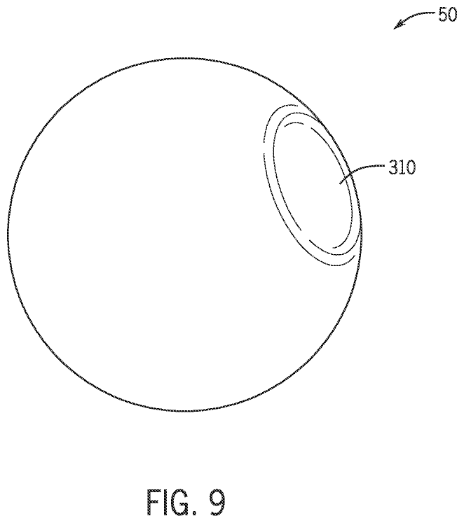

FIG. 9 is a perspective view of an embodiment of the electronic enclosure 50 having a generally spherical shape. The illustrated electronic enclosure 50 may form a geometric feature 310, such as a depression, that may concentrate stress during a pressure buildup within the electronic enclosure 50. Thus, during the pressure buildup, the amount of stress at the geometric feature 310 may be relatively greater than the amount of stress at other portions of the electronic enclosure 50. For instance, the geometric feature 310 may divert stress away from other portions of the electronic enclosure 50, thereby reducing a potential change in geometry at the other portions of the electronic enclosure 50 during a pressure buildup.

The geometric feature 310 may be formed during arrangement of walls of the electronic enclosure 50 instead of during a separate operation dedicated to forming the geometric feature 310 into the electronic enclosure 50. For this reason, a thickness of the wall of the electronic enclosure 50 may be approximately the same throughout different parts of the electronic enclosure 50. In this manner, a structural integrity of the wall may be maintained, such as in comparison to a geometric feature formed by removing a portion of the wall.

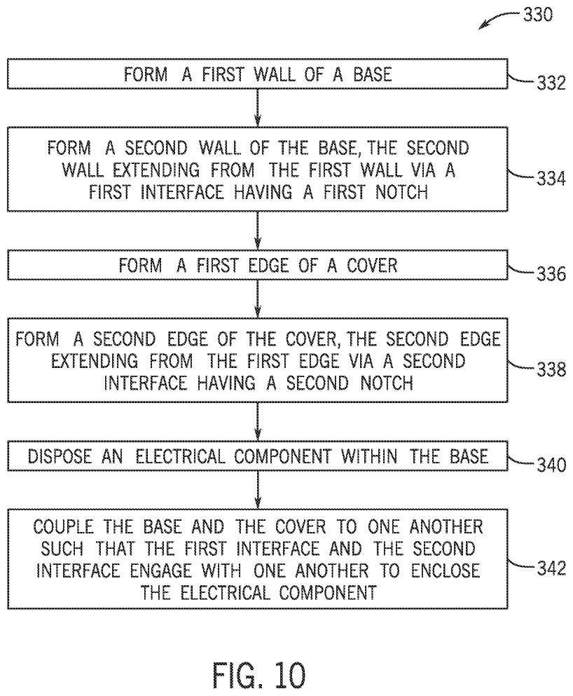

FIG. 10 illustrates a method 330 for manufacturing an electronic enclosure, such as any suitable electronic enclosure 50 described above. In some embodiments, the operation of the method 330 may be performed automatically, such as via machinery. In additional or alternative embodiments, the operation of the method 330 may be at least partially performed by a user, such as using a manually or physically applied force. It should be noted that additional operations may be performed with respect to the method 330. Moreover, certain operations of the method 330 may be removed, modified, and/or performed in a different order.

At block 332, a first wall of a base may be formed. By way of example, the base may be formed from metal (e.g., sheet metal), and the metal may be bent to form the first wall. At block 334, a second wall of the base may be formed, and the second wall may extend from the first wall via a first interface having a first notch. For instance, the second wall of the base may be formed by bending the metal with respect to the first wall. Such bending of the metal with respect to the first wall may also directly form the first interface having the first notch, such as by forming one or more arcuate portions that sequentially extend from the first wall to the second wall. In this manner, upon forming the second wall, the first notch may already be implemented in the base (e.g., without having to perform a separate operation dedicated to forming the first notch, such as after forming the first wall and the second wall).

At block 336, a first edge of a cover may be formed. As an example, the cover may similarly be formed bending metal. At block 338, a second edge of the cover may be formed, and the second edge may extend from the first edge via a second interface having a second notch. For example, the second edge of the cover may also be formed by bending the metal, and the second interface having the second notch may be directly formed via bending of the metal. As such, upon forming the second edge, the second notch may already be implemented in the cover (e.g., without having to perform a separate operation dedicated to forming the second notch, such as after forming the first edge and the second edge).

At block 340, an electrical component may be disposed within the base. For instance, formation of the first wall and/or the second wall may define an internal volume, and the electrical component may be positioned within the internal volume. In an embodiment, the electrical component may be secured to the base to block relative movement between the electrical component and the base. For example, a fastener, an adhesive, a weld, an interference fit, a punch, any other suitable feature, or any combination thereof may be used to secure the electrical component within the base.

At block 342, the base and the cover may be coupled to one another to enclose the electrical component within the internal volume of the electronic enclosure. For example, the first interface of the base and the second interface of the cover may be in engagement with one another upon coupling the base and the cover to one another. Any suitable coupling feature, such as a fastener, a weld, an adhesive, another suitable coupling feature, or any combination thereof may be used to couple the base and the cover to one another. In certain embodiments, the base (e.g., the first wall, the second wall) may include a flange to increase an area of contact between the base and the cover, and the coupling feature may be applied to the flange to facilitate coupling of the base and the cover to one another. Additionally, in some embodiments, the coupling between the base and the cover may seal (e.g., hermetically seal) the internal volume from an external environment. In this manner, the coupling between the base and the cover may better protect the electrical component from external elements to maintain a desirable structural integrity of the electrical component, improve a useful lifespan of the electrical component, maintain a desirable operation of the electrical component, and so forth.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An electronic enclosure, comprising:
a first wall extending along a first direction;
a second wall extending along a second direction crosswise to the first direction, wherein the first wall and the second wall cooperatively define at least a portion of an internal volume of the electronic enclosure; and
an interface formed between the first wall and the second wall such that the first wall and the second wall extend from one another via the interface, wherein the interface comprises a notch configured to concentrate stress caused by pressure buildup within the internal volume.

2. The electronic enclosure of claim 1, wherein the notch comprises an arcuate portion extending from the first wall to the second wall.

3. The electronic enclosure of claim 2, wherein the first wall extends linearly to a first end of the arcuate portion, and the second wall extends linearly to a second end of the arcuate portion.

4. The electronic enclosure of claim 2, wherein the arcuate portion is a first arcuate portion, the notch comprises a second arcuate portion extending from a first end of the first arcuate portion and a third arcuate portion extending from a second end of the first arcuate portion, the first wall extends to the second arcuate portion, and the second wall extends to the third arcuate portion.

5. The electronic enclosure of claim 1, comprising a cover configured to couple to the first wall and the second wall to hermetically seal the internal volume of the electronic enclosure.

6. The electronic enclosure of claim 5, wherein the first wall comprises a flange, and the cover is configured to couple to the flange via a weld.

7. The electronic enclosure of claim 1, wherein the first wall and the second wall extend from one another via the interface to arrange the electronic enclosure in an L-shape configuration.

8. An electronic enclosure, comprising:
an arcuate portion;
a first wall extending from a first end of the arcuate portion; and
a second wall extending from a second end of the arcuate portion;
wherein the first wall, the second wall, and the arcuate portion cooperatively define at least a portion of an internal volume of the electronic enclosure, the arcuate portion curves inwardly with respect to the first wall and the second wall, and the arcuate portion is configured to concentrate stress caused by pressure buildup within the internal volume.

9. The electronic enclosure of claim 8, comprising a third wall extending from the first wall, wherein the arcuate portion is configured to divert stress away from the third wall during the pressure buildup within the internal volume.

10. The electronic enclosure of claim 8, wherein the first wall and the second wall are oriented generally perpendicular to one another.

11. The electronic enclosure of claim 8, wherein the first wall spans a first dimension in a first direction, the second wall spans a second dimension in a second direction, and the first dimension and the second dimension are different from one another.

12. The electronic enclosure of claim 8, comprising a base that comprises the arcuate portion, the first wall, and the second wall.

13. The electronic enclosure of claim 12, comprising a cover that comprises:
an additional arcuate portion;
a first edge extending from a first end of the additional arcuate portion; and
a second edge extending from a second end of the additional arcuate portion.

14. The electronic enclosure of claim 13, wherein the arcuate portion of the base and the additional arcuate portion of the cover are in engagement with one another in an assembled configuration of the electronic enclosure.

15. The electronic enclosure of claim 14, wherein the cover is welded to the base in the assembled configuration of the electronic enclosure to hermetically seal the internal volume.

16. An electronic enclosure, comprising:
a base having a first wall, a second wall, and a first interface extending between the first wall and the second wall, wherein the first interface forms a first notch; and
a cover having a first edge, a second edge, and a second interface extending between the first edge and the second edge, wherein the second interface forms a second notch;
wherein the base and the cover are coupled to one another in an assembled configuration of the electronic enclosure to enclose an internal volume of the electronic enclosure, and the first notch and the second notch are configured to concentrate stress caused by pressure buildup in the internal volume, thereby facilitating relief of the pressure buildup from within the electronic enclosure at the first notch and the second notch.

17. The electronic enclosure of claim 16, wherein, in the assembled configuration of the electronic enclosure, the first wall of the base and the first edge of the cover are in engagement with one another, and the second wall of the base and the second edge of the cover are in engagement with one another.

18. The electronic enclosure of claim 16, wherein the first wall and the second wall extend to opposite ends of the first notch, and the first edge and the second edge extend to opposite ends of the second notch.

19. The electronic enclosure of claim 16, wherein the base comprises a third wall extending from the first wall, the cover comprises a third edge extending from the first edge, and the first notch and the second notch are configured to divert stress concentration away from the third wall and the third edge to the first interface and the second interface, respectively, during the pressure buildup in the internal volume.

20. The electronic enclosure of claim 16, wherein the first wall and the second wall are oriented obliquely with respect to one another, the first edge and the second edge are oriented obliquely with respect to one another, or both.
